(19) United States
(12) Patent Application Publication
(10) Pub. No.: US 2025/0319453 A1
(43) Pub. Date: Oct. 16, 2025

(54) HYDROTHERMALLY STABLE HYDROCARBON TRAP BY CONTROLLING THE COMPOSITION RATIO OF CATIONS WITHIN THE BETA ZEOLITE AND PREPARATION METHOD THEREOF

(71) Applicant: Korea University Research and Business Foundation, Seoul (KR)

(72) Inventors: Jungkyu CHOI, Seoul (KR); Wenhao Zeng, Seoul (KR); Jaehee SHIM, Seoul (KR)

(21) Appl. No.: 19/172,980

(22) Filed: Apr. 8, 2025

(30) Foreign Application Priority Data
Apr. 11, 2024 (KR) 10-2024-0048535

(51) Int. Cl. B01J 20/18; B01D 53/06; B01J 20/32

(52) U.S. Cl. CPC B01J 20/186; B01D 53/06; B01J 20/3204; B01J 20/3217; B01J 20/3225; B01D 2253/1085; B01D 2253/1122; B01D 2253/1124; B01D 2253/25

(57) ABSTRACT

The present invention relates to a hydrocarbon adsorbent with enhanced hydrothermal stability and a method for manufacturing the same by controlling the cation ratio within BEA zeolite. More specifically, the invention provides a hydrocarbon adsorbent in which the cation composition within the BEA zeolite structure is precisely controlled to enable effective adsorption and oxidation of hydrocarbons emitted during the cold-start period, thereby improving hydrothermal stability and maintaining structural integrity under harsh conditions. The hydrocarbon adsorbent according to the present invention exhibits improved hydrothermal stability and maintains excellent hydrocarbon adsorption and desorption performance even after undergoing high-temperature hydrothermal treatment in the presence of moisture.

### CROSS-REFERENCE TO RELATED APPLICATIONS

This application claims priority to and the benefit of Korean Patent Application No. 10-2024-0048535 filed in the Korean Intellectual Property Office on Apr. 11, 2024, the entire contents of which are incorporated herein by reference.

### TECHNICAL FIELD

The present invention relates to a hydrocarbon adsorbent with improved hydrothermal stability by controlling the cation ratio within BEA zeolite, and a method for manufacturing the same. More specifically, the present invention is directed to a hydrocarbon adsorbent capable of effectively adsorbing and oxidizing hydrocarbons emitted during the cold start phase by adjusting the cation composition ratio in the BEA zeolite framework, thereby enhancing hydrothermal stability.

### BACKGROUND ART

With increasing awareness of air pollution, emission regulations on exhaust gases such as carbon monoxide (CO), nitrogen oxides (NOx), hydrocarbons (HC), and particulate matter (PM) from gasoline and diesel vehicles are being increasingly tightened in the United States, Europe, and other regions. In particular, the Euro emission standards have evolved from Euro 1 in 1992 to Euro 6d in 2020, requiring a reduction of HC emissions by more than approximately 80% compared to 1992 levels. In gasoline vehicles, it is known that approximately 50-80% of the total HC emissions during driving are emitted during the cold start period, a phase where the three-way catalysts (TWCs), which are responsible for oxidizing HC, exhibit little to no activity. To reduce HC emissions during this cold start period, extensive research has been conducted on hydrocarbon traps (HC traps). A hydrocarbon trap is a device that adsorbs hydrocarbons during the cold start phase and subsequently desorbs them when the temperature reaches the activation temperature of the TWC (approximately 200-300° C.).

Zeolites with physical and chemical stability have been widely studied as potential materials for HC traps. The performance of HC traps is typically evaluated by measuring the adsorption and desorption behavior of representative hydrocarbon species in gasoline exhaust, such as propene and toluene. Several studies have focused on the effects of zeolite framework structure, Si/Al ratio, and the presence of metal species on HC trap performance. It has been reported that zeolites with higher Al content (i.e., lower Si/Al ratio) exhibit higher hydrocarbon adsorption capacity.

Among various zeolite structures, ZSM-5 and beta (BEA) zeolites have shown superior performance. However, HC traps composed solely of such zeolites exhibit limited adsorption and oxidation capacity below 300° C. and are therefore insufficient in treating hydrocarbons during the cold start period before the TWC becomes active. Furthermore, the performance of these HC traps deteriorates significantly in the presence of high moisture content (˜10 vol %).

Studies have reported that Cu-exchanged BEA zeolites, prepared via ion exchange processes, show enhanced adsorption of propene and toluene compared to H+-form BEA zeolites. When a higher amount of copper is used for ion exchange, residual copper exists as copper oxide (CuO) on the surface of the BEA zeolite, which is known to contribute to the oxidation of propene and toluene.

However, Cu-loaded BEA zeolites suffer from poor hydrothermal stability. Under simulated long-term vehicle operating conditions (i.e., treatment at 800° C. for 24 hours in air containing 10 vol % water vapor), the BEA zeolite framework is damaged, leading to a significant decrease in hydrocarbon adsorption performance.

To address these issues, there is a demand for the development of hydrocarbon adsorbents that can effectively adsorb hydrocarbons at temperatures lower than the activation temperature of TWCs and maintain structural and particle integrity even under high-temperature conditions that simulate real-world vehicle operation.

### SUMMARY OF THE INVENTION

The present invention is directed to a hydrocarbon adsorbent with improved hydrothermal stability and a method of manufacturing the same, by controlling the cation composition within the BEA zeolite framework. The objective of the present invention is to provide a hydrocarbon adsorbent and its preparation method, wherein the hydrothermal stability is enhanced by adjusting the internal cation ratio of the BEA zeolite, thereby overcoming the aforementioned problems.

In one embodiment of the present invention, the hydrocarbon adsorbent comprises: BEA zeolite particles containing cations; metal ions chemically bonded to the BEA zeolite particles; and metal oxides disposed on an outer surface of the BEA zeolite particles.

The BEA zeolite particles are Na⁺-form zeolite particles prepared by ion exchange from H+-form BEA zeolite having a Si/Al ratio of 1 to 50.

The cations comprise sodium and hydrogen cations, wherein the molar ratio of sodium to aluminum (Na/Al) in the BEA zeolite particles is 0.7 or less.

The hydrocarbon adsorbent satisfies Equation 1 under the following conditions: A mixed gas comprising 100 ppm of propene, 100 ppm of toluene, 1 vol % oxygen (O₂), 10 vol % water vapor (H₂O), and 500 ppm argon (Ar), with helium (He) as the balance gas, is introduced at a flow rate of 100 mL/min with a space velocity (F/W) of 100,000 mL/g·h. The adsorbent is exposed to the gas at 70° C. for 5 minutes, heated to 600° C. at a rate of 53° C./min over 10 minutes, and held at 600° C. for 5 minutes.

$$Efficiency ( \% ) = ( 1 - \frac{\int {C}_{HC , outlet}}{\int {C}_{HC , inlet}} ) \times 100 \qquad [ Equation 1 ]$$

(Equation 1 represents the hydrocarbon conversion efficiency,
wherein C_{HC_inlet} is the concentration of total hydrocarbons, including propene and toluene, introduced into the hydrocarbon adsorbent,
C_{HC_outlet} is the concentration of total hydrocarbons, including propene and toluene, discharged from the hydrocarbon adsorbent,
and the efficiency is calculated based on the total concentration of hydrocarbons including propene and toluene measured up to a final temperature of 300° C.)

The hydrocarbon adsorbent may further comprise a hydrothermal treatment step in which the adsorbent is treated at 600° C. to 900° C. for 1 to 36 hours with 5 to 15 vol % steam.

The metal ions are chemically bonded within the pores formed in the BEA zeolite particles.

The metal ions comprise one or more metal cations selected from Groups 3 to 12 of the periodic table, and the metal oxides comprise one or more metal oxides of the same elemental groups.

Preferably, the metal ions comprise one or more cations selected from iron (Fe), cobalt (Co), nickel (Ni), copper (Cu), zinc (Zn), rhodium (Rh), and cadmium (Cd), and the metal oxides comprise one or more oxides of the same metals.

In another embodiment, the present invention provides a method for preparing a hydrocarbon adsorbent, comprising: adjusting the cation ratio of BEA zeolite particles by an ion exchange method; and mixing the cation-adjusted BEA zeolite particles with a solution containing metal ions to form metal ions and metal oxides;

wherein the BEA zeolite particles are Na⁺-form BEA zeolite prepared from H⁺-form BEA zeolite having a Si/Al ratio of 1 to 50 through ion exchange,
wherein the cations comprise sodium and hydrogen cations,
and wherein the step of adjusting the cation ratio comprises controlling the molar ratio of sodium to aluminum (Na/Al) to be 0.7 or less.

The step of adjusting the cation ratio includes mixing the zeolite particles with an aqueous sodium salt solution, wherein the sodium salt solution comprises one or more selected from sodium nitrate, sodium chloride, sodium acetate, sodium persulfate, sodium bicarbonate, and sodium formate.

The step of forming the metal ions and metal oxides is preferably performed by a wet impregnation method.

The method may further comprise hydrothermal treatment of the hydrocarbon adsorbent at 600° C. to 900° C. for 1 to 36 hours with 5 to 15 vol % steam.

The metal ions comprise one or more cations selected from elements of Groups 3 to 12 of the periodic table.

The hydrocarbon adsorbent according to the present invention exhibits improved hydrothermal stability and, even after undergoing hydrothermal treatment under high-temperature and high-humidity conditions, maintains excellent hydrocarbon adsorption and desorption performance.

### BRIEF DESCRIPTION OF THE DRAWINGS

FIG. 1 is a set of scanning electron microscope (SEM) and transmission electron microscope (TEM) images of a hydrocarbon adsorbent according to an embodiment of the present invention.

FIG. 2 is a set of SEM and TEM images of hydrocarbon adsorbents prepared in Examples 1, 4, 6, and 9.

FIG. 3 is a graph showing the cold start performance test results of the hydrocarbon adsorbent.

FIG. 4 is a graph showing the adsorption capacity of propene and toluene by the hydrocarbon adsorbent.

FIG. 5 is a graph showing the hydrocarbon conversion efficiency of the hydrocarbon adsorbent.

FIG. 6 is a graph showing the CO-adsorption FT-IR spectrum of the hydrocarbon adsorbent before hydrothermal treatment.

FIG. 7 is a graph showing the CO-adsorption FT-IR spectrum of the hydrocarbon adsorbent after hydrothermal treatment.

### DETAILED DESCRIPTION

An exemplary embodiment of the present invention will be described with reference to the accompanying drawings, and an object and the configuration, and the features of the present invention will be understood well through the detailed description.

The exemplary embodiment described above is only to describe exemplary embodiment of the present invention and is not limited to the exemplary embodiment, and various modifications and variations are possible by those skilled in the art within the spirit and claims of the present invention, and it will be said that the modifications and variations fall within the scope of the technical rights of the present invention.

Hereinafter, with reference to the drawings, an embodiment of the present invention will be described in detail, directed to a “hydrocarbon adsorbent with enhanced hydrothermal stability by controlling the cation ratio within BEA zeolite and a method for manufacturing the same.”

In this specification, the term “total hydrocarbons” refers to hydrocarbon content expressed in terms of methane equivalents. Specifically, gases such as propene and toluene are quantified by converting their amounts into methane equivalents using gas chromatography (GC-FID).

Therefore, the unit of hydrocarbon adsorption capacity, mmol_{CH}/g, is based on GC analysis.

Previous studies have disclosed hydrocarbon adsorbents formed by impregnating zeolites with copper via ion exchange, or by increasing copper loading such that residual copper exists in the form of copper oxide.

Conventional approaches focused on adjusting the Si/Al ratio, zeolite structure, or type of metal species.

In contrast, the present invention relates to a hydrocarbon adsorbent in which the distribution of metal ions and metal oxides is controlled by regulating the cation ratio at the active sites of BEA zeolite, resulting in excellent hydrothermal stability even under actual vehicle operation conditions.

The hydrocarbon adsorbent of the present invention comprises:
BEA zeolite particles containing cations;
metal ions chemically bonded within the BEA zeolite particles; and
metal oxides disposed on the outer surface of the BEA zeolite particles.

The cations include sodium and hydrogen ions, and the molar ratio of sodium to aluminum (Na/Al) in the BEA zeolite particles is 0.7 or less.

Specifically, the Na/Al ratio may be 0.01 to 0.7, 0.1 to 0.7, or 0.4 to 0.7. Maintaining this ratio helps preserve the structural integrity of the particles after hydrothermal treatment, thereby maintaining performance.

The BEA zeolite is obtained by ion-exchanging H⁺-form BEA zeolite (Si/Al=1 to 50) to form Na⁺-form zeolite. A proper cation ratio enables better dispersion of metal ions into pores and reduces the particle size of surface metal oxides, enhancing adsorption performance.

The size of the hydrocarbon adsorbent may range from 50 to 5000 nm. Specifically, the size of the hydrocarbon adsorbent may range from 50 to 2000 nm, from 100 to 1500 nm, or from 150 to 800 nm.

In addition, the hydrocarbon adsorbent comprises metal ions impregnated into the micropores already formed within the BEA zeolite particles, and metal oxides disposed on the surface of the BEA zeolite particles.

Specifically, the micropore volume of the hydrocarbon adsorbent may be in the range of 0.1 to 0.25 cm³/g, 0.15 to 0.25 cm³/g, or 0.2 to 0.22 cm³/g.

Such micropores are formed within the BEA zeolite particles, and the impregnation of metal ions into these micropores may enhance the adsorption capacity for hydrocarbons such as propene and toluene.

The metal ions may include one or more metal cations selected from elements of Groups 3 to 12 of the periodic table.

Specifically, the metal ions may include one or more cations of iron (Fe), cobalt (Co), nickel (Ni), copper (Cu), zinc (Zn), rhodium (Rh), or cadmium (Cd).

More specifically, the metal ions may be monovalent, divalent, or trivalent ions of the aforementioned metals, such as Fe⁺, Fe²⁺, Fe³⁺, Co⁺, Co²⁺, Nit, Ni²⁺, Cut, or Cu²⁺.

The metal ions may be bonded within the pores formed in the zeolite particles, thereby enhancing the hydrocarbon adsorption performance.

The metal oxides may include one or more oxides of metals selected from elements of Groups 3 to 12 of the periodic table. Specifically, the metal oxides may include oxides of iron, cobalt, nickel, copper, zinc, rhodium, or cadmium. More particularly, the metal oxides may be selected from FeO, Fe₃O₄, Fe₂O₃, Co₃O₄, CoO, NiO, Cu₂O, Cu₂O₃, or CuO.

For example, the metal oxides may be formed on the surface of the zeolite particles and may have an average diameter in the range of 1 to 10 nm.

More specifically, the average diameter of the metal oxides may be in the range of 1 to 9 nm, 1 to 7 nm, 2 to 8 nm, or 2 to 6 nm.

By forming such metal oxides on the surface of the zeolite particles, the hydrocarbon adsorbent according to the present invention can exhibit a lower hydrocarbon oxidation temperature and improved hydrothermal stability.

The hydrocarbon adsorbent according to the present invention may have a micropore volume (V₁) of 0.1 cm³/g or more for pores with diameters of 1 nm or less.

The metal cations may be present in an amount corresponding to 50 to 90% of the maximum loading capacity of the zeolite, and the metal oxides may be present in an amount corresponding to 60 to 80% of the maximum loading capacity of the zeolite.

For example, the metal oxides may be formed on the surface of the zeolite particles and may have an average diameter in the range of 1 to 10 nm.

More specifically, the average diameter of the metal oxides may be in the range of 1 to 9 nm, 1 to 7 nm, 2 to 8 nm, or 2 to 6 nm.

By forming such metal oxides on the surface of the zeolite particles, the hydrocarbon adsorbent according to the present invention can exhibit a lower hydrocarbon oxidation temperature and improved hydrothermal stability.

The hydrocarbon adsorbent according to the present invention may have a micropore volume (V₁) of 0.1 cm³/g or more for pores with diameters of 1 nm or less.

The metal cations may be present in an amount corresponding to 50 to 90% of the maximum loading capacity of the zeolite, and the metal oxides may be present in an amount corresponding to 60 to 80% of the maximum loading capacity of the zeolite.

The hydrocarbon conversion efficiency (Efficiency) of the adsorbent satisfies the following Equation 1:

$$Efficiency ( \% ) = ( 1 - \frac{\int {C}_{HC , outlet}}{\int {C}_{HC , inlet}} ) \times 100 \qquad [ Equation 1 ]$$

Where C_{HC_inlet} and C_{HC_outlet} denote the total hydrocarbon concentrations, including propene and toluene, at the inlet and outlet of the hydrocarbon adsorbent. The values are integrated up to 300° C., the typical TWC light-off temperature.

Equation 1 is used to calculate the hydrocarbon adsorption capacity of the hydrocarbon adsorbent by measuring the amount of hydrocarbons introduced into the hydrocarbon adsorbent and the amount discharged from it.

The calculation is based on the ratio between the total amount of hydrocarbons introduced into the adsorbent and the amount emitted from the adsorbent, integrated up to a temperature of 300° C.

In this case, the hydrocarbon conversion efficiency (Efficiency) may be 40% or more, 45% or more, 50% or more, 55% or more, or 60% or more, based on the total amount of hydrocarbons.

In addition, the hydrocarbon adsorbent according to the present invention may exhibit hydrocarbon adsorption at temperatures of 300° C. or lower and hydrocarbon oxidation at temperatures of 200° C. or higher.

Specifically, the hydrocarbon adsorbent may show hydrocarbon adsorption in the temperature range of 70° C. to 300° C. or 100° C. to 300° C., and hydrocarbon oxidation at temperatures of 210° C. or higher, 220° C. or higher, 230° C. or higher, 240° C. or higher, or 250° C. or higher.

Typically, 50 to 80% of the total hydrocarbons emitted during driving are released during the cold-start period (i.e., below 300° C.).

Due to the above characteristics, the hydrocarbon adsorbent of the present invention is capable of efficiently adsorbing and oxidizing hydrocarbons even during the cold-start period, while also exhibiting excellent hydrothermal stability.

The hydrocarbon adsorbent according to the present invention may be hydrothermally treated at a temperature ranging from 600° C. to 900° C. for a duration of 1 to 36 hours. More specifically, the hydrothermal treatment may be performed at a temperature range of 600° C. to 850° C., 600° C. to 800° C., 650° C. to 800° C., or 700° C. to 800° C., and for a duration of 1 to 24 hours, 12 to 36 hours, or 12 to 24 hours.

In this case, the gas hourly space velocity (GHSV) of the simulated exhaust gas containing steam, based on the weight of the hydrocarbon adsorbent, may be in the range of 10,000 to 200,000 mL/g·h, or 100,000 to 200,000 mL/g·h.

These conditions are considered to simulate severe environments comparable to prolonged operation of an automobile.

Under such hydrothermal treatment conditions, the performance of the hydrocarbon adsorbent in adsorbing and oxidizing hydrocarbons in the presence of steam may deteriorate, and its durability may also be reduced.

For example, the hydrothermally treated hydrocarbon adsorbent may exhibit a hydrocarbon conversion efficiency of 5% or more, 10% or more, 15% or more, 20% or more, 25% or more, or 30% or more as defined by Equation 1.

Although the hydrothermally treated hydrocarbon adsorbent may show a relatively lower hydrocarbon conversion efficiency compared to a non-treated adsorbent, a hydrocarbon adsorbent having a sodium-to-aluminum molar ratio (Na/Al) of 0.7 or less—such as in the range of 0.01 to 0.7, 0.1 to 0.7, or 0.4 to 0.7—demonstrates improved thermal durability and superior hydrocarbon conversion efficiency after hydrothermal treatment compared to an adsorbent having a Na/Al ratio greater than 0.7.

In addition, the present invention provides a method comprising: a step of adjusting the cation ratio of BEA zeolite particles by an ion exchange method; and a step of mixing the cation-adjusted BEA zeolite particles with a solution containing metal ions to form metal ions and metal oxides.

The step of adjusting the cation ratio is characterized by controlling the molar ratio of sodium to aluminum (Na/Al) in the zeolite particles to be 0.7 or less.

In the step of adjusting the cation ratio, the BEA zeolite particles may include hydrogen ion-containing zeolite (H⁺-form zeolite) and sodium ion-containing zeolite (Na⁺-form zeolite).

The BEA zeolite having a controlled sodium-to-aluminum molar ratio (Na/Al) may be prepared by subjecting a BEA zeolite precursor to an ion exchange process followed by calcination, wherein the hydrogen ions in the BEA zeolite are replaced with sodium ions.

The step of adjusting the cation ratio may include mixing the BEA zeolite particles with an aqueous sodium salt solution.

The sodium salt solution may comprise one or more salts selected from the group consisting of sodium nitrate, sodium chloride, sodium acetate, sodium persulfate, sodium bicarbonate, and sodium formate.

The sodium salt solution may be mixed with an ammonium ion-containing zeolite (NH⁺-form zeolite), and in such case, sodium ions may replace a portion of the ammonium ions present in the BEA zeolite.

After this exchange, the zeolite is subjected to calcination, during which the remaining ammonium ions are converted to hydrogen ions.

This process may result in an increase in the sodium-to-aluminum molar ratio (Na/Al) in the BEA zeolite particles.

The Na/Al ratio of the BEA zeolite may be precisely controlled by adjusting the concentration of the sodium salt solution and the reaction time between the sodium salt solution and the BEA zeolite particles.

Specifically, the concentration of the sodium salt solution may be in the range of 0.001 M to 1 M, 0.005 M to 1 M, or 0.001 M to 0.9 M.

The sodium salt solution and the BEA zeolite particles may be mixed and stirred at a temperature of 20° C. to 30° C. for a duration of 20 to 30 hours, 25 to 30 hours, or 20 to 25 hours.

By stirring the BEA zeolite particles with the sodium salt solution for a predetermined period as described above, the sodium-to-aluminum molar ratio (Na/Al) in the BEA zeolite particles can be effectively controlled, thereby improving the hydrothermal stability of the resulting hydrocarbon adsorbent.

The hydrocarbon adsorbent prepared according to the manufacturing method of the present invention may have a sodium-to-aluminum molar ratio (Na/Al) in the BEA zeolite particles of 0.7 or less, such as in the range of 0.01 to 0.7, 0.1 to 0.7, or 0.4 to 0.7. By forming BEA zeolite particles with such a Na/Al ratio, the adsorption performance can be maintained even after hydrothermal treatment.

Subsequently, the mixed solution of the BEA zeolite particles and the sodium salt solution may be subjected to centrifugation and decantation to obtain a precipitate.

The obtained precipitate may be mixed with distilled water and the separation process may be repeated one or more times to further purify the material.

The resulting precipitate may be calcined at a temperature of 500° C. to 700° C. for 10 to 20 hours under an air flow of 500 mL/min.

Specifically, the obtained precipitate may be calcined under an air flow of 500 mL/min at a temperature of 500 to 650° C. or 500 to 600° C. for a duration of 10 to 17 hours or 10 to 15 hours, with a heating rate of approximately 1° C./min.

Through this process, BEA zeolite particles having a controlled sodium ion ratio can be obtained.

The step of forming the metal ions and metal oxides may be performed by impregnating the BEA zeolite particles—having a controlled sodium-to-aluminum molar ratio—with a metal precursor solution containing metal ions, using a wet impregnation method.

In this case, the metal content may be in the range of 1 to 9 wt %, 2 to 8 wt %, 3 to 8 wt %, or 4 to 7 wt %.

This process may additionally include a drying step and a calcination step.

### Example 1: Synthesis of CuNaB

H⁺-form BEA zeolite with a Si/Al ratio of 19 was converted to Na⁺-form BEA zeolite via ion exchange using sodium nitrate (NaNO₃). By adjusting the NaNO₃ solution concentration, the Na/Al ratio in the zeolite was controlled.

Specifically, 5 g of NH₄⁺-form BEA zeolite was added to 500 mL of 0.001-1 M NaNO₃ solution (Product No. 221341, Sigma-Aldrich) and stirred at room temperature for 24 hours. A BEA zeolite sample with Na/Al=0.9 was obtained by performing ion exchange three times using 1 M NaNO₃.

The resulting sample was centrifuged, washed three times, and dried overnight at 70° C. Prior to wet impregnation, the Na/NH₄-BEA zeolite was calcined at 550° C. for 6 hours at a heating rate of 1° C./min in 500 mL/min air to yield Na/H-form BEA zeolite. A wet impregnation method was used to load 5 wt % Cu onto the particles. The Cu precursor solution was prepared by dissolving 1.00 g of Cu(NO₃)₂·3H₂O (Product No. 61197, Sigma-Aldrich) in 83.33 g of distilled water. 5 g of Na/H-form BEA zeolite was added to the solution. After mixing, water was removed at 40° C. using rotary evaporation. The resulting material was dried at 100° C. for 4 hours and calcined at 550° C. for 6 hours (1° C./min) under 500 mL/min airflow.

The final products were designated CuNaB(x), where x indicates the Na/Al molar ratio (x=0, 0.1, 0.4, 0.7, 0.9).

The Cu precursor solution was prepared by dissolving 1.00 g of Cu(NO₃)₂·3H₂O (Product No. 61197, Sigma-Aldrich) in 83.33 g of deionized water (DI).

Subsequently, 5 g of Na/H-form BEA zeolite was added to the prepared precursor solution.

After mixing, the deionized water contained in the resulting mixture was removed using a rotary evaporator at 40° C.

The recovered solid was then dried at 100° C. for 4 hours.

Finally, the dried particles were calcined at 550° C. for 6 hours under an air flow of 500 mL/min with a heating rate of 1° C./min, thereby obtaining Cu-impregnated Na⁺/H⁺-form BEA zeolite.

Additionally, the fresh samples were subjected to hydrothermal treatment (HT).

CuNaB(x) samples (x=0, 0.1, 0.4, 0.7, and 0.9) were exposed to an air stream containing 10 mol % steam at 800° C. for 24 hours, with a space velocity of approximately 100,000 mL·g⁻¹·h⁻¹.

For convenience, the hydrothermally treated samples are referred to as CuNaB(x)_HT, where x=0, 0.1, 0.4, 0.7, and 0.9.

Tables 1 and 2 show the results of ion exchange of H⁺-form BEA zeolites using sodium nitrate (NaNO₃), including the measured Si/Al and Na/Al molar ratios, as well as the elemental analysis of particles impregnated with 5 wt % Cu.

TABLE 1

| | Sample | Si/Al | Na/Al | Cu wt % |
|---|---|---|---|---|
| Example 1 | CuNaB(0) | 17.6 ± 0.8 | 0.0 ± 0.0 | 5.8 ± 0.3 |
| Example 2 | CuNaB(0.1) | 17.5 ± 1.3 | 0.1 ± 0.0 | 5.7 ± 0.6 |
| Example 3 | CuNaB(0.4) | 17.8 ± 1.6 | 0.4 ± 0.1 | 5.5 ± 0.4 |
| Example 4 | CuNaB(0.7) | 17.6 ± 1.0 | 0.7 ± 0.1 | 5.4 ± 0.4 |
| Example 5 | CuNaB(0.9) | 17.1 ± 0.6 | 0.9 ± 0.1 | 5.9 ± 0.4 |

[ [symbol] 2]

| | Sample | Si/Al | Na/Al | Cu wt % |
|---|---|---|---|---|
| Example 6 | CuNaB(0)_HT | 17.9 ± 0.2 | 0.0 ± 0.0 | 5.3 ± 0.3 |
| Example 7 | CuNaB(0.1)_HT | 17.7 ± 1.1 | 0.1 ± 0.0 | 5.4 ± 0.5 |
| Example 8 | CuNaB(0.4)_HT | 18.1 ± 0.4 | 0.4 ± 0.0 | 5.5 ± 0.1 |
| Example 9 | CuNaB(0.7)_HT | 17.2 ± 1.2 | 0.7 ± 0.0 | 5.4 ± 0.9 |
| Example 10 | CuNaB(0.9)_HT | 17.4 ± 1.5 | 0.9 ± 0.1 | 5.5 ± 0.5 |

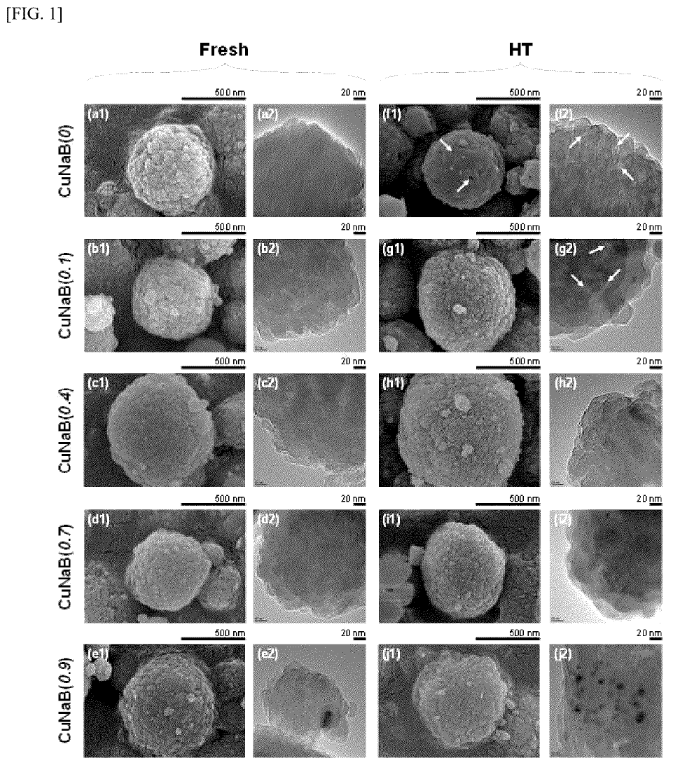

FIG. 1 shows scanning electron microscope (SEM) and transmission electron microscope (TEM) images of a hydrocarbon adsorbent according to one embodiment of the present invention.

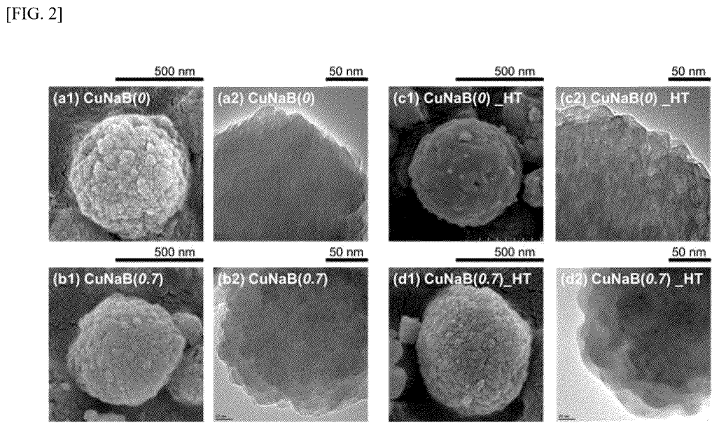

FIG. 2, in particular, shows SEM and TEM images of the hydrocarbon adsorbents prepared in Examples 1, 4, 6, and 9.

TEM images of the samples from Examples 1 through 10 were acquired using a field-emission transmission electron microscope (Tecnai G2 F30 S-Twin, FEI).

In FIG. 1, the two columns on the left show images of fresh (non-hydrothermally treated) samples, while the two columns on the right show hydrothermally treated particles.

In each set, the left image was taken by SEM with a scale bar of 500 nm, and the right image was taken by TEM with a scale bar of 20 nm.

Rows 1 through 5 correspond to particles with Na/Al molar ratios (x) of 0, 0.1, 0.4, 0.7, and 0.9, respectively.

As shown in FIGS. 1 and 2, CuO particles were observed on the outer surface of the Cu-loaded samples in Example 1 (CuNaB(0)) and Example 4 (CuNaB(0.7)).

It was confirmed that larger CuO particles were formed in Example 4, which had a higher sodium content.

In addition, after hydrothermal treatment, the sample of Example 6 (CuNaB(0)_HT) exhibited a deformed surface morphology, indicating a collapse of the original particle structure observed in Example 1.

However, in the case of Example 9 (CuNaB(0.7)_HT), the particle morphology remained similar to that of the original Example 4 sample, demonstrating superior structural stability.

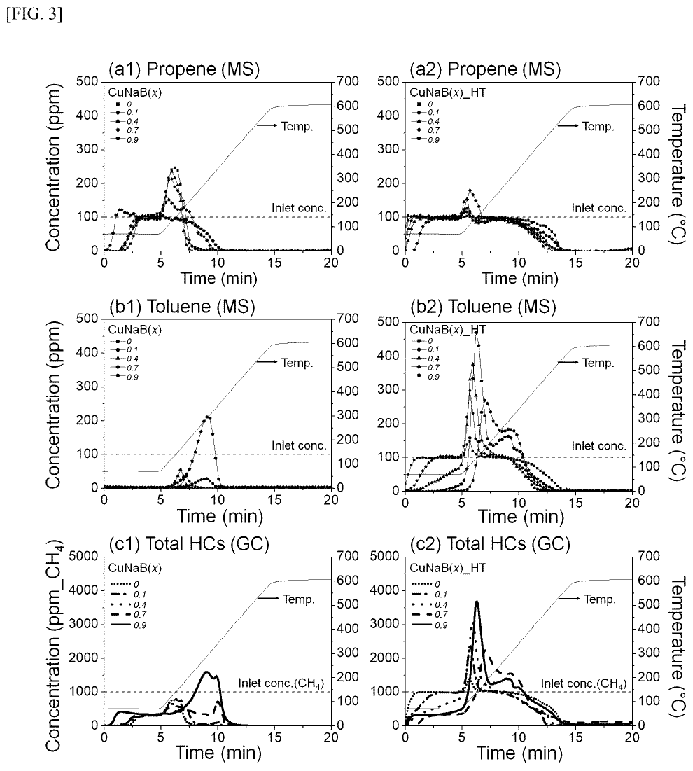

FIG. 3 is a graph illustrating the cold-start test (CST) results of the hydrocarbon adsorbents.

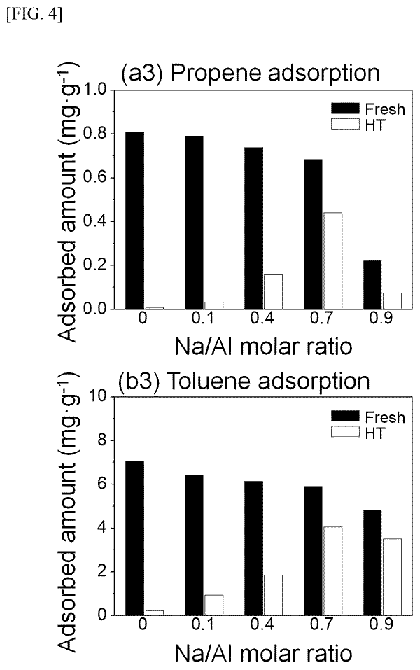

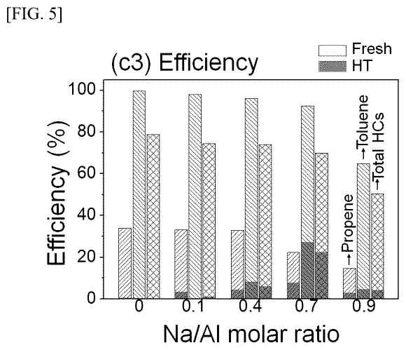

FIG. 4 shows the adsorption amounts of propene and toluene, and FIG. 5 depicts the overall hydrocarbon conversion efficiency of the hydrocarbon adsorbents.

As shown in FIGS. 3 to 5, CST performance was evaluated for both CuNaB(x) and hydrothermally treated CuNaB(x)_HT samples.

For CuNaB(x), it was observed that decreasing the Na/Al molar ratio led to an increase in both propene adsorption (FIG. 3, section a1, and FIG. 4) and toluene adsorption (FIG. 3, section b1, and FIG. 4), as well as in overall hydrocarbon conversion efficiency (FIG. 5).

In the case of CuNaB(x)_HT samples, the CST results showed that CuNaB(0)_HT lost most of its original hydrocarbon conversion efficiency (FIG. 5), indicating degradation after hydrothermal treatment.

However, CuNaB(0.7)_HT exhibited the highest propene adsorption (FIG. 3, section a2, and FIG. 4), toluene adsorption (FIG. 3, section b2, and FIG. 4), and hydrocarbon conversion efficiency (FIG. 5) among the hydrothermally treated samples.

For reference, the adsorption amounts of propene and toluene shown in FIGS. 3 to 5 were calculated based on the amount adsorbed until the outlet concentrations of the respective gases became equal to their inlet concentrations (100 ppm each).

The CST measurement conditions were as follows: a mixed gas containing 100 ppm of propene, 100 ppm of toluene, 1 vol % oxygen (O₂), 10 vol % steam (H₂O), and 500 ppm argon (Ar), with helium (He) as the balance gas, was introduced at a flow rate of 100 mL/min under a feed-to-weight ratio (F/W) of 100,000 mL/g·h.

The temperature profile for the CST test involved holding the sample at 70° C. for 5 minutes, followed by heating to 600° C. at a ramp rate of 53° C./min, and then maintaining the temperature at 600° C. for an additional 5 minutes.

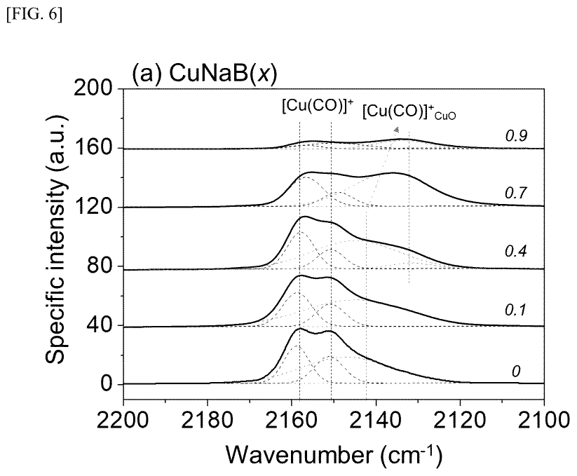

FIG. 6 shows the CO-adsorption FT-IR spectra of the hydrocarbon adsorbents before hydrothermal treatment, and

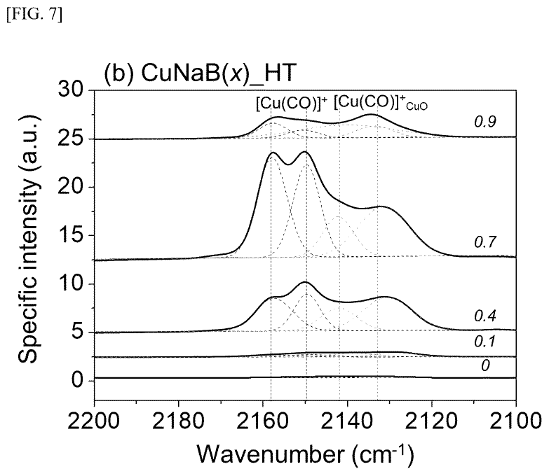

FIG. 7 shows the CO-adsorption FT-IR spectra of the hydrocarbon adsorbents after hydrothermal treatment.

Through CO adsorption, the amount of Cut ions present in CuNaB(x) and CuNaB(x)_HT samples was estimated.

Generally, CO selectively adsorbs onto Cut ions to form monocarbonyl species ([Cu(CO)]⁺).

Thus, the presence of Cut ions can be confirmed by identifying characteristic peaks in the CO-adsorption FT-IR spectra.

The two primary peaks observed around 2157 and 2150 cm⁻¹ are attributed to [Cu—CO]⁺ species located within the zeolite framework.

Additional peaks appearing near 2140 and 2130 cm⁻¹ may be assigned to [Cu—CO]⁺ species formed on CuO particles.

This is possible because Cut ions, after hydrolysis and interaction with oxygen species in the CuO lattice, become coordinatively unsaturated and capable of binding with CO molecules.

In all fresh samples, the estimated amount of Cut ions monotonically decreased as the Na/Al molar ratio increased.

However, among the hydrothermally treated samples, Example 9, which had an optimal ratio of Na⁺ ions, retained the highest amount of Cut ions even after hydrothermal aging. In the case of CuNaB(x), the intensity of the [Cu(CO)]⁺ signal decreased as the Na/Al molar ratio increased, which correlated with a decrease in hydrocarbon adsorption.

Accordingly, it can be concluded that a higher amount of Cut ions present within the BEA zeolite framework leads to enhanced hydrocarbon conversion efficiency.

Similarly, for the hydrothermally treated CuNaB(x)_HT samples, the amount of [Cu(CO)]⁺ species showed a trend consistent with the hydrocarbon conversion efficiency.

Among all the hydrothermally treated samples, Example 9 retained the highest amount of Cu⁺ ions.

Therefore, Example 4 (CuNaB(0.7)), which had an optimal cation ratio, demonstrated the highest hydrothermal stability and retained the greatest amount of Cut ions after hydrothermal treatment.

As a result, it also exhibited superior hydrocarbon conversion performance compared to the other treated samples.

While the preferred embodiments of the present invention have been described above with reference to the accompanying drawings, it will be understood by those skilled in the art that various modifications, changes, and substitutions may be made without departing from the spirit or essential characteristics of the invention.

Therefore, the embodiments described above are intended only as illustrative examples and should not be considered as limiting in any way.

The scope of the present invention is defined by the following claims, and all modifications, equivalents, and variations falling within the scope and meaning of the claims are intended to be included within the scope of the present invention.

What is claimed is:

1. A hydrocarbon adsorbent comprising:
BEA zeolite particles containing cations; metal ions chemically bonded to the BEA zeolite particles; and metal oxides disposed on an outer surface of the BEA zeolite particles;
wherein the BEA zeolite particles are Na⁺-form BEA zeolite particles prepared by ion exchange from H⁺-form BEA zeolite having a Si/Al ratio of 1 to 50;
wherein the cations comprise sodium and hydrogen cations, and a molar ratio of sodium to aluminum (Na/Al) in the BEA zeolite particles is 0.7 or less;

2. The hydrocarbon adsorbent of claim 1,
wherein the hydrocarbon adsorbent satisfies Equation 1 under the following test conditions:
a mixed gas comprising 100 ppm of propene, 100 ppm of toluene, 1 vol % oxygen (O₂), 10 vol % water vapor (H₂O), and 500 ppm argon (Ar), with helium (He) as the balance gas, is introduced at a flow rate of 100 mL/min, corresponding to a space velocity (F/W) of 100,000 mL/g·h;
the hydrocarbon adsorbent is exposed to the mixed gas at 70° C. for 5 minutes, followed by heating to 600° C. at a rate of 53° C./min, and then maintained at 600° C. for 5 minutes;
and Equation 1 is defined as follows:
$$Efficiency ( \% ) = ( 1 - \frac{\int {C}_{HC , outlet}}{\int {C}_{HC , inlet}} ) \times 100 \qquad [ Equation 1 ]$$
(Equation 1 represents the hydrocarbon conversion efficiency,
wherein C_{HC_inlet} is the concentration of total hydrocarbons, including propene and toluene, introduced into the hydrocarbon adsorbent,
C_{HC_outlet} is the concentration of total hydrocarbons, including propene and toluene, discharged from the hydrocarbon adsorbent,
and the efficiency is calculated based on the total concentration of hydrocarbons
including propene and toluene measured up to a final temperature of 300° C.)

3. The hydrocarbon adsorbent of claim 1, further comprising hydrothermal treatment of the hydrocarbon adsorbent at a temperature of 600° C. to 900° C. for 1 to 36 hours in an atmosphere containing 5 to 15 vol % steam.

4. The hydrocarbon adsorbent of claim 1, wherein the metal ions are chemically bonded within the pores formed in the BEA zeolite particles.

5. The hydrocarbon adsorbent of claim 1, wherein the metal ions comprise one or more metal cations selected from Groups 3 to 12 of the periodic table, and the metal oxides comprise one or more metal oxides of elements selected from Groups 3 to 12 of the periodic table.

6. The hydrocarbon adsorbent of claim 5, wherein the metal ions comprise one or more metal cations selected from the group consisting of iron (Fe), cobalt (Co), nickel (Ni), copper (Cu), zinc (Zn), rhodium (Rh), and cadmium (Cd), and the metal oxides comprise one or more metal oxides selected from the same group.

7. A method for preparing a hydrocarbon adsorbent according to claim 1, comprising:
adjusting the cation ratio of BEA zeolite particles by ion exchange; and
mixing the cation-adjusted BEA zeolite particles with a solution containing metal ions to form metal ions and metal oxides,
wherein the BEA zeolite particles are Na⁺-form BEA zeolite particles prepared by ion exchange from H⁺-form BEA zeolite having a Si/Al ratio of 1 to 50,
wherein the cations comprise sodium and hydrogen cations, and
wherein the step of adjusting the cation ratio comprises controlling a molar ratio of sodium to aluminum (Na/Al) in the BEA zeolite particles to 0.7 or less.

8. The method of claim 7, wherein the step of adjusting the cation ratio comprises mixing the BEA zeolite particles with an aqueous sodium salt solution, and
the sodium salt solution comprises at least one selected from the group consisting of sodium nitrate, sodium chloride, sodium acetate, sodium persulfate, sodium bicarbonate, and sodium formate.

9. The method of claim 7, wherein the step of forming the metal ions and metal oxides is performed by a wet impregnation method.

10. The method of claim 7, further comprising hydrothermal treatment of the hydrocarbon adsorbent at a temperature of 600° C. to 900° C. for 1 to 36 hours in an atmosphere containing 5 to 15 vol % steam.

11. The method of claim 7, wherein the metal ions comprise one or more metal cations selected from Groups 3 to 12 of the periodic table.
